(19) United States
(12) Patent Application Publication
(10) Pub. No.: US 2021/0326696 A1
(43) Pub. Date: Oct. 21, 2021

(54) METHOD AND APPARATUS FOR FORECASTING POWER DEMAND

(71) Applicant: SANGMYUNG UNIVERSITY INDUSTRY-ACADEMY COOPERATION FOUNDATION, Seoul (KR)

(72) Inventors: Dong Keun KIM, Seoul (KR); Eun Jeong CHOI, Bucheon-si (KR); Soo Hwan CHO, Suji-gu, Yongin-si (KR)

(73) Assignee: SANGMYUNG UNIVERSITY INDUSTRY-ACADEMY COOPERATION FOUNDATION, Seoul (KR)

(21) Appl. No.: 16/953,653

(22) Filed: Nov. 20, 2020

(30) Foreign Application Priority Data
Apr. 8, 2020 (KR) 10-2020-0042972

(51) Int. Cl. G06N 3/08; G06Q 10/04; G06Q 50/06

(52) U.S. Cl. CPC G06N 3/08; G06Q 50/06; G06Q 10/04

(57) ABSTRACT

Provided are a method and apparatus for forecasting power demand. The method of forecasting power demand includes forming weighted power demand data by assigning different weights to power demand data according to the frequency of the power demand data, and forming a power demand forecasting model by recurrent neural network (RNN)-based deep learning using the weighted power demand data. From the power demand forecasting model, a power demand forecasting value is extracted using a forecast target label or index information.

### CROSS-REFERENCE TO RELATED APPLICATION

This application is based on and claims priority under 35 U.S.C. § 119 to Korean Patent Application No. 10-2020-0042972, filed on Apr. 8, 2020, in the Korean Intellectual Property Office, the disclosure of which is incorporated by reference herein in its entirety.

### BACKGROUND

### 1. Field

The present disclosure relates to the design of a novel customized power demand forecasting algorithm based on deep learning for power demand patterns.

### 2. Description of the Related Art

Accurate power demand forecasting is important in the field of a smart grid technology with an intelligent power grid structure. The prospect of the smart grid business is once again being reexamined in view of the transformation of low-carbon energy and renewable energy business due to rising oil prices and environmental problems. Research is conducted to diversify new industries by trying to combine them in various fields, such as information technology (IT), in preparation for energy issues.

In general, energy may be efficiently managed through a smart grid system using hardware and software that reflect the latest technology, thereby increasing the economic benefits in terms of energy.

As one of the several key functions of the smart grid, including the function of energy scheduling management, a system that forecasts power demand in facilities is required. Understanding the volatility of power demand through power demand forecasting is necessary for economic benefits along with measures against blackout. Power demand forecasting interacts with intelligent demand response to monitor energy in real time and manage energy demand.

The use of power demand response may bring economic benefits, which may lead to additional benefits such as cost savings and environmental conservation. In addition, energy efficiency is the most profitable way for society to ensure energy supply, and thus, research to consume energy efficiently have been actively conducted.

Forecasting energy usage to ensure adequate energy supply is closely related to energy efficiency increasing methods. Energy efficiency may help the countries achieve multiple objectives such as lowering the energy bill, reducing energy dependence, and decreasing greenhouse gas (GHG) and non-GHG emission, while increasing the level of economic activity by raising the share of renewable energy. In fact, countries such as China and Austria have set energy intensity targets as a percentage reduction compared to a certain base year. Accurate forecasting of energy demand may reduce energy waste and improve energy sustainability. Indeed, many attempts are currently have been made to forecast such power demand.

In the case of using a support vector machine (SVM), which is the most similar and generalized study, it is difficult to analyze an energy usage dataset in a facility-customized manner. In addition, it is difficult to deduce only the past power usage data because a change in a specific time zone may not be recognized by using only existing machine learning algorithms. There is a need for a method to increase the accuracy of energy demand by forecasting the variability of power demand in all time zones. Since this method is needed at each process, including data collection, preprocessing, feature extraction, and the like, power demand forecasting systems consume a lot of time and efforts.

### SUMMARY

The present disclosure provides a method and apparatus for forecasting power demand to more accurately forecast power demand and reduce unnecessary energy demand management costs.

Additional aspects will be set forth in part in the description which follows and, in part, will be apparent from the description, or may be learned by practice of the presented embodiments of the disclosure.

A method of forecasting power demand, according to an embodiment of the present disclosure, includes;

measuring and collecting periodic power demand data for one facility or each facility of a plurality of same or different facilities;

forming weighted power demand data by assigning different weights to the power demand data according to the frequency of the power demand data;

forming a power demand forecasting model by recurrent neural network (RN N)-based deep learning using the weighted power demand data; and

extracting a power demand forecasting value of a label or index by using a forecast target label or index information in the power demand forecasting model.

The forming of the power demand forecasting model by the RNN-based deep learning may be based on long short-term memory (LSTM).

In the setting of hyper-parameters, a number of hidden layers may be set to 3, a number of nodes may be set to 10, a learning rate may be set to 0.01, and a number of iterations may be set to 180.

Hyperbolic tangent (tank) and stochastic gradient descent (SGD) may be respectively used as an activation function and an optimization algorithm of a layer of the LSTM.

A mean square error (MSE) may be used as a loss function of the layer of the LSTM.

Deeplearning4J (4J) using a graphic processing unit (GPU) may be applied to the RNN-based deep learning.

An apparatus for forecasting power demand, according to an embodiment of the present disclosure, includes;

a power demand forecasting unit in the form of software and configured to perform the method of forecasting power demand;

a storage device configured to store the power demand forecasting unit;

a processor configured to perform data processing requested by the power demand forecasting unit;

a memory used by the processor; and

a display configured to display a result of processing by the power demand forecasting unit.

The power demand forecasting unit may be further configured to obtain the power demand forecasting model based on long short-term memory (LSTM) through the RNN-based deep learning.

The power demand forecasting unit may be further configured to set hyper-parameters of the LSTM, wherein a number of hidden layers may be set to 3, a number of nodes may be set to 10, a learning rate may be set to 0.01, and a number of iterations may be set to 180.

Hyperbolic tangent (tank) and stochastic gradient descent (SGD) may be respectively used as an activation function and an optimization algorithm of a layer of the LSTM.

A mean square error (MSE) may be used as a loss function of the layer of the LSTM.

The apparatus for forecasting power demand may further a graphic processing unit (GPU), wherein the power demand forecasting unit may be further configured to apply deeplearning4J (DL4J) using the GPU to the deep learning.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a hybrid forecasting model (HFM) according to an embodiment;

FIG. 2 illustrates a maximum average power requirement data set for each facility building;

FIG. 3 illustrates a forecasting method according to input and output data for each of three models used in experiments according to the present disclosure;

FIG. 4 illustrates the structure of a machine learning-based HFM for power demand used in experiments according to an embodiment;

FIG. 5A is a graph showing comparison of results of forecasting power demand in summer by using the existing powerLSTM model and the HFM of the present disclosure; and

FIG. 5B is a graph showing comparison of results of forecasting power demand in winter by using the existing powerLSTM model and the HFM of the present disclosure.

### DETAILED DESCRIPTION

Reference will now be made in detail to embodiments, examples of which are illustrated in the accompanying drawings, wherein like reference numerals refer to Ike elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

Embodiments of the present disclosure now will be described more fully hereinafter with reference to the accompanying drawings. The present disclosure may, however, be embodied in many different forms and should not be construed as limited to the example embodiments set forth herein. Rather, these embodiments are provided so that this disclosure will be thorough and complete, and will fully convey the scope of the disclosure to one of ordinary skill in the art. Like reference numerals refer to like elements throughout. Further, various elements and regions are schematically illustrated in the drawings. Thus, the present disclosure is not limited to relative sizes or relative distances illustrated in the accompanying drawings.

It will be understood that, although the terms first, second, etc. may be used herein to describe various elements, these elements should not be limited by these terms. These terms are only used to distinguish one element from another. For example, a first element could be termed a second element, and vice versa, without departing from the scope of the present disclosure.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “includes”, “including”, “has”, “having”, “comprises” and/or “comprising” used herein specify the presence of stated features, integers, steps, operations, members, components, and/or groups thereof, but do not preclude the presence or addition of one or more other features, integers, steps, operations, members, components, and/or groups thereof.

Unless otherwise defined, all terms including technical and scientific terms used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

When a certain embodiment may be implemented differently, a specific process order may be performed differently from the described order. For example, two consecutively described processes may be performed substantially at the same time or performed in an order opposite to the described order.

In addition, a term such as “ . . . portion”, “ . . . unit”, or “module” denotes a unit that processes at least one function or operation, which may be implemented as computer-based hardware, software running on a computer, or a combination of hardware and software.

Hardware is based on a general computer system including a main body, a keyboard, a monitor, and the like, and may include an input device for inputting an image.

Hereinafter, a method and apparatus for forecasting power demand, according to an embodiment, will be described with reference to the accompanying drawings.

The present disclosure proposes a method (hereinafter, referred to as a power demand forecasting method) of forecasting power demand by using a hybrid forecasting model (HFM) that may check the fluctuation of inadequate power demand by comparing the power demand with actual power usage, and an apparatus (hereinafter, referred to as a power demand forecasting apparatus) using the power demand forecasting method.

A power demand forecasting method according to an embodiment of the present disclosure includes:

1) measuring and collecting periodic power demand data using power for one facility or each facility of a plurality of same or different facilities,

2) forming weighted power demand data by assigning different weights to the power demand data according to the frequency of the power demand data,

3) forming a power demand forecasting model by recurrent neural network (RN N)-based deep learning using the weighted power demand data, and

4) extracting a power demand value of an index by using a forecast target label or forecast index information in the power demand forecasting model.

According to an embodiment, the RNN-based deep learning may obtain the power demand forecasting model based on long short-term memory (LSTM).

According to a specific embodiment, in the hyper-parameter setting of the LSTM, the number of hidden layers may be set to 3, the number of nodes may be set to 10, a learning rate may be set to 0.01, and the number of iterations may be set to 180.

Hyperbolic tangent (tank) and stochastic gradient descent (SGD) may be respectively used as an activation function and an optimization algorithm of an LSTM layer, and in the LSTM, a mean square error (MSE) may be applied as a loss function. In addition, deeplearning4J (MAJ) using a graphic processing unit (GPU) may be applied to the deep learning.

A power demand forecasting apparatus according to an embodiment of the present disclosure may include a power demand forecasting unit or power demand forecasting program in the form of computer-based hardware and software.

The power demand forecasting program includes an algorithm for performing each operation of the power demand forecasting method. The power demand forecasting program may be implemented by a single piece of software or a group of a plurality of pieces of software in the form of modules separated by function. The power demand forecasting unit may be assisted by hardware as a partial element.

The computer-based hardware may include a storage device that stores the power demand forecasting unit, a processor that performs data processing requested by the power demand forecasting unit, a memory that is used by the processor, and a display that displays a result of processing by the power demand forecasting unit.

According to an embodiment, the power demand forecasting apparatus may further include a CPU, and the power demand forecasting unit may apply DL4J using the CPU.

According to an embodiment of the present disclosure, power demand forecasting for each facility may be performed based on deep learning. Because facilities are different from each other in view of power usage, such as power usage or their own usage capacity, and each of the facilities has its own unique power demand pattern, a deep learning system based on the variability of the power demand pattern may be used. In this case, because each type of facility has a relatively one pattern, data may be analyzed by season, day, month, and time, and patterns of volatility of power demand may be extracted. In analyzing complex time series data such as power usage, a machine learning algorithm based on regression analysis may be used.

The purpose of the present disclosure is to present a power demand forecasting method that provides high accuracy of forecasted data. The goal of the power demand forecasting method is to reduce the error rate thereof by more than 30% compared to other methodologies. In addition, a power demand forecasting method, which may identify the features of power demand patterns and be used efficiently for each facility, is proposed. The most important function used to evaluate volatility is the usage forecasting study. Most of the existing studies have been conducted to forecast and compare power demand by using an autoregressive distributed lag (ARDL) model and a mixed-data sampling (MIDAS) method. These methods are used to estimate values by numerical calculation using a variety of data formats that require power. Therefore, the methods are applied very actively applied in the area of power demand forecasting. Hereinafter, use of two approaches for power demand forecasting is described.

One way of forecasting power demand is an ARDL method, which is one of the most widely used dynamic regression analyses for analyzing time series data. The ARDL method, which is widely used as a methodology of error correction and cointegration, is a method mainly used in social and economic fields to infer numerical values. In the power demand forecasting, the ARDL method is used to perform power demand forecasting on the assumption that monthly power demand to be forecasted is affected by the power demand several years ago. The number of days when a heating unit was used and the number of days when a cooling unit was used may also be included in the past month's independent variables to use them to forecast power demand. The level of statistical significance may be confirmed by using different ways according to usage.

$${y}_{t} = μ + {\sum }_{i = 1}^{{A}_{y}} {α}_{i} {y}_{t - i} + {\sum }_{j = 1}^{{A}_{x}} {β}_{j} {x}_{t - j} + {u}_{t} \qquad [ Equation 1 ]$$

Equation 1 is commonly used as an ARDL(Ay, Ax) model with a dependent variable Ay and an independent variable Ax to forecast monthly data yₜ from weekly data xₜ for a j-th week of a t-th month. In this case, it is assumed that one month includes 4 weeks j=1, . . . , and 4). However, power demand forecasting is very sensitive to temperature and seasonal factors due to the characteristics of power usage, and thus, the older the past data, the less influence on the forecast data. Therefore, different weights have to be assigned to each historical data to more accurately forecast power demand. When each week's data in Equation 1 is assigned a different weight, Equation 2 may be derived, wherein w denotes a variable representing the week.

$${y}_{t} = a + {\sum }_{i = 1}^{{A}_{y}} {α}_{i} {y}_{t - i} + {\sum }_{j = 1}^{{A}_{x}} {\sum }_{w = 1}^{4} {β}_{w , t - j} {x}_{w , t - j} + {b}_{t} \qquad [ Equation 2 ]$$

In the case of ARDL(1,2) using Equation 2,

yₜ=α+α₁yₜ₋₁+(β_{(1,t-1)}x_{(1,t-1)}+β_{(2,t-2)}x_{(2,t-1)}+ . . . +β_{(4,t-4)}x_{(4,t-4)})+(β_{(1,t-2)}x_{(1,t-2)}+ . . . +β_{(4,t-2)}x_{(4,t-2)}+bₜ

the number of estimated coefficients of x is eight (2×4). The data used in this study are daily data, and thus, the number of estimated coefficient is 60 (2×30), assuming 30 days per month. In this case, it is difficult to estimate the model itself and the reliability of an estimation result is very low,

Like the ARDL method, the existing power demand forecasting system using the MIDAS method uses a regression model, which is used to calculate GDP in economics. The biggest advantage of the MIDAS method is that weights may be automatically assigned to each input data by using a weight function,

$${y}_{t} = a + {\sum }_{i = 1}^{{D}_{y}} {α}_{i} {y}_{t - i} + β {\sum }_{j = 1}^{{D}_{x} \times {N}_{w}} φ ( j ; θ ) {x}_{w - j} + {b}_{t} \qquad [ Equation 3 ]$$

Equation 3 includes a function φ(j; θ) that imposes different weights on high-frequency data. In Equation 38 denotes a parameter vector of the weight function, and Nw denotes the number of weeks. Therefore, when forecasting power demand by the MIDAS method, it is possible to forecast power demand by considering various external factors besides power demand data without adjustment to the weight function. In order to assign different weights according to the frequency, the weight function used in the MIDAS method was used in this study. In other MIDAS regression forecasting studies, by setting the temperature, the number of working days, the income variable, and the price variable as independent variables, the accuracy of short-term power demand forecasting could have been improved. In addition, in the other MIDAS regression forecasting studies, Saturdays were set to be half days, holidays and Sundays were excluded, and the number of workdays was added up to perform power demand forecasting. As a result, in the existing studies, monthly data was useful in the power demand forecasting, and a relatively high accuracy was obtained when monthly and weekly heating, cooling differences and temperature, etc., were reflected. Also, as it is possible to analyze the pattern of volatility of power demand by separating weekday and weekend power demand data, smooth forecasting may be made for facilities where there is a large difference in power demand between weekdays and weekends, such as companies and city halls. Also, we focused on this feature in power demand and conducted a forecasting analysis. In the MIDAS method, various types of weight functions for calculating weights may be used, and thus, the results may be different for each weight function. Therefore, it is important to select an appropriate weight function, That is, the key idea of the model is to simplify the estimation of the weights imposed on the high frequency variables using only a few parameters.

An embodiment of the present disclosure uses a Hybrid Forecasting Model (HEM) to forecast power demand by using deep learning, but pre-processes daily, weekly, monthly or seasonal power demand data used for deep learning and use the pre-processed power demand data as initial input data in machine learning. In the pre-processing technique, different weights are assigned to input data to further enhance the differences and independence between individual data. In the pre-processing for this, for example, the function of Equation 3 may be used, but the technical scope of the embodiment of the present disclosure is not limited thereto, Weight assigning may be differentiated according to the frequency of each data. For example, a high weight may be assigned to data with a high frequency, and a low weight may be assigned to data with a low frequency. In this way, in differentiating the weight assigning, a weight value may be differentially determined linearly or nonlinearly according to a change in frequency. RNN-based deep learning may be applied to machine learning using, as input data, data to which a weight is differentially assigned according to frequency, etc., and more specifically, LSTM may be partially applied or entirely applied to the machine learning.

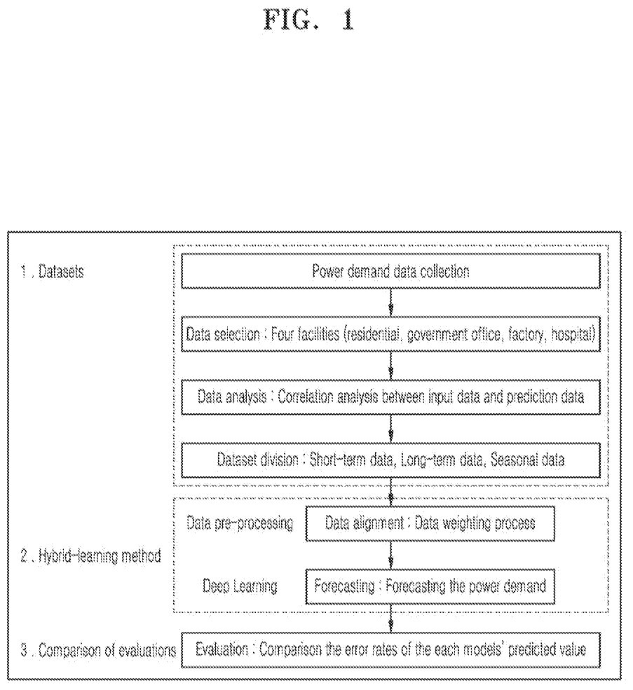

Hereinafter, an embodiment of the present disclosure and data used therein will be described. FIG. 1 illustrates an HFM according to an embodiment.

In a power demand volatility evaluation model, it is most important to understand the patterns of power demand data for power demand forecasting. In order to identify power demand patterns, data were classified into short-term data and long-term data. Experiments were conducted through the collection of data for each facility according to power demand. In order to evaluate forecasting models by using data from various periods, demand forecasting was performed using three models, i.e., MIDAS, LSTM, and HFM and the forecasting error rates of the three models were measured,

Using these three models, experiments were performed with short-term data and long-term data to compare differences in the forecasting accuracy. However, in the case of residential facilities with large variable power demand patterns, it is important to understand external variables such as the seasonal, weather, and holiday aspects, rather than merely a period (short-term and long-term) aspect. Then, the performance of the HFM model according to the present embodiment was compared to those of other existing studies.

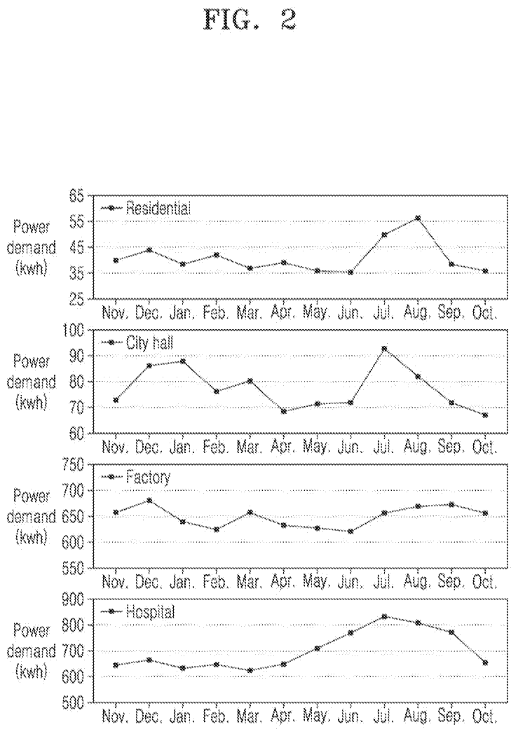

FIG. 2 illustrates a maximum average power requirement data set for a facility building.

In FIG. 2, in the case of residential and public institution buildings (e.g., a city hall), the average maximum power demand tends to increase in summer (June to August). However, the overall average maximum power demand of the public institution building was higher than that of the residential building, and in summer and winter (November to December), the maximum power demand of the public institution building showed no significant difference compared to that of the residential building. Although there is a big difference in the power demand for each facility, a change in the average maximum power demand of a factory building was insignificant and an amount of 600-700 kWh of power was consumed in one year. In the case of hospital facility such as a university hospital building, the maximum power demand thereof was highest among those of four facilities and the highest power demand was shown between May and September when the temperature rose. However, the residential building showed the largest difference in the maximum power demand in summer and winter, while it showed similar patterns in other seasons except summer. Therefore, experiments regarding seasonal power demand forecasting for the residential building were further conducted to reduce the error rate of power demand forecasting for the residential building.

From November 2016 to October 2017, power demand data was collected, as data set used in the experiments, by sensors installed in various facility buildings (residential, hospital, farm, city hall, factory, company, etc.). Of the collected data, power demands from four facility buildings (residential, factory, hospital, and city hole) were used to calculate the accuracy of power demand forecasting according to the power demand patterns of this study. The collected data consisted of 288 data per day for every 5 minutes, enabling detailed power pattern analysis, unlike other existing studies on quarterly power usage. In order to collect short-term and long-term data for the four facility buildings and seasonal data for the residential building, input data was set using different data components, as shown in Table 1. In seasonal data, data collected from November 2016 to January 2017 for winter and from June 2016 to August 2016 for summer was used based on the seasonal characteristics of Korea.

Table 1 below shows the structure of input and output data sets,

TABLE 1

| Data Component | | Short-Term Data | Long-Term Data | Seasonal Data |
|---|---|---|---|---|
| Input | Train data | 2 days × 288 data | 8 days × 288 data | 6 days × 288 data |
| | Test data | 1 day × 288 data | 4 days × 288 data | 3 days × 288 data |
| Output | Forecasting data | 1 day × 288 data | 4 days × 288 data | 3 days × 288 data |

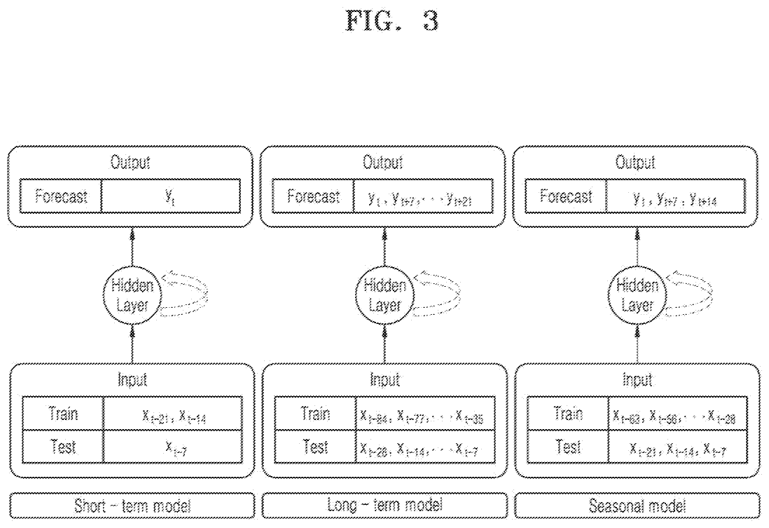

In the LSTM model, the ratio of train data of the input data to test data of the input data was set to 2:1, and Table 1 shows the structure of the input and output data sets. Because power demand patterns are similar for each day of the week, input data (train data and test data) and output data consist of the same day (7-day lag) data. In the short-term forecast, three 7-day lags data in the previous three weeks were used to forecast the next week's data for the same day of the week. In the long-term forecast, twelve 7-day lags data during the previous 12 weeks were used to forecast data for the same day during the next four weeks. For example, every Monday, data during the previous 12 weeks was used as train and test data when the power demand data for every Monday was forecasted during the next four weeks. Likewise, in seasonal data forecast, the previous nine weeks' 7-day lags data were used to forecast the next three weeks. FIG. 3 illustrates a forecasting method according to input and output data for each of the three models.

Hereinafter, a data processing process will be described.

In a forecasting method using the HEM according to the present embodiment, a pre-processing of assigning different weights to input data that affects the variability of forecasted data is performed before using the power demand as input data in a deep learning method. In the pre-processing, a pre-processing of weighting daily input data (x) was performed using a weight function. Power demand data is expressed as follows.

xₜⁿ={x₁ⁿ,x₂ⁿ,x₃ⁿ, . . . ,xₜⁿ}

The above equation shows power demand data at t-th time of an n-th week's one day, where n is a number (serial number) in a specific period. The weight is calculated by using a weight function without directly estimating a weight assigned to the past value of an information variable. The weight function to determine weights for high frequency values by using a regression analysis method is as follows.

$$( n ; θ ) = \frac{exp ( {θ}_{1} n + ⋯ + {θ}_{t} n )}{{\sum }_{i = 1}^{N} exp ( {θ}_{1} n + ⋯ + {θ}_{t} n )} \qquad [ Equation 4 ]$$

A result of data pre-processing by Equation 4 is expressed by Equation 5.

x′ₜⁿ= [symbol] xₜⁿ+b [Equation 5]

W denotes a vector matrix.

x denotes raw data.

n denotes a serial number or number in a specific period.

t denotes a serial number or ordinal number of data in a specific period.

b denotes a bias coefficient.

Equation 4 denotes an ALMOD exponential function, which is widely used as a weight function of the MIDAS regression method, e denotes the parameter vector of the weight function, and the shape of the weight function varies depending on the value of 0. The value of 0 was set in the range from −0.002 to 0.01 for exponential increase of the weight. W denotes the vector matrix of W(n; θ) and b denotes a bias coefficient. When a value after the calculation performed with the weight is too different from the raw data, the value is adjusted through the adjustment of the bias value. The bias value is set to −0.03 to 4.25.

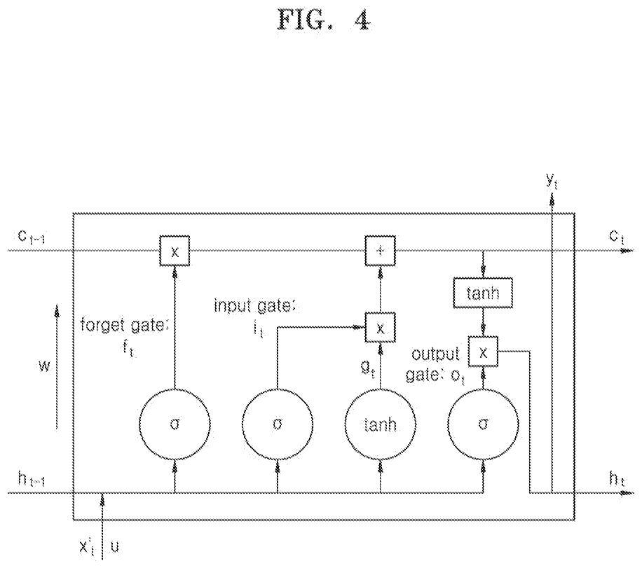

The forecasting mechanism of the LSTM is used for time-series forecasting. Accordingly, based on the LSTM model that is suitable for time-series forecasting, a new HFM model, which reflects the weight function value used in the MIDAS model, was derived by considering the power demand's volatility. FIG. 4 illustrates the structure of a machine learning-based HFM for power demand used in the experiments of the present embodiment.

iₜ=σ(x′ₜUᵢ+hₜ₋₁Wᵢ) [Equation 6]

fₜ=σ(x′ₜU_{f}+hₜ₋₁W_{f}) [Equation 7]

oₜ=σ(x′ₜUₒ+hₜ₋₁Wₒ) [Equation 8]

gₜ=tanh(x′ₜU_{g}+hₜ₋₁W_{g}) [Equation 9]

Cₜ=σ(fₜCₜ₋₁+iₜgₜ) [Equation 10]

hₜ=tanh(Cₜ)oₜ[Equation 11]

In Equations 6 to 11,

x′ₜ denotes an input pre-processed with a weight,

Cₜ denotes a memory of the current cell,

Cₜ₋₁ denotes a memory of the previous cell,

hₜ denotes an output of the current cell,

hₜ₋₁ denotes an output of the previous cell,

σ denotes a sigmoid layer,

W, U denote weight factors,

X denotes a matrix multiplication, and

+ denotes a matrix addition.

To evaluate forecasting performance through the experiments described above, statistical analysis was performed using the mean absolute percentage error (MAPE), root mean square error (RMSE), and R-squared (R²). Equations for evaluating each model are as follows.

$$\begin{matrix}MAPE = \frac{100}{N} {\sum }_{i = 1}^{N} \vert \frac{{H}_{i}^{*} - {H}_{i}}{{H}_{i}} \vert & [ Equation 12 ] \\ RMSE = \sqrt{\frac{1}{N} {\sum }_{i = 1}^{N} {( {H}_{i}^{*} - {H}_{i} )}^{2}} & [ Equation 13 ] \\ {R}^{2} = 1 - \frac{{\sum }_{i = 1}^{N} {( {H}_{i}^{*} - {H}_{i} )}^{2}}{{\sum }_{i = 1}^{N} {( \overline{H} - {H}_{i} )}^{2}} & [ Equation 14 ]\end{matrix}$$

Here,

H*ᵢ denotes a forecasted value of data i,

Hᵢ denotes an actual value of the data i, and

H̅ denotes the mean of Hᵢ

The range of R² is [0, 1], and the closer to 1, the stronger the explanatory power of the model. Because the power demand data used in the experiments of the present embodiment varies in scale depending on the facilities, R² was calculated to compare forecasted results according to the facilities.

In the experiments of the HFM according to the present embodiment, deeplearning4J (DL4J) was used to construct a power demand forecasting model using LSTM, which is the one of the most appropriate deep learning-based time series data forecasting methods. DL4J has a characteristic that it is easy to construct an environment that may use a GPU. Accordingly, the present disclosure proposes an HFM based on the DL4J method as an embodiment to optimize power demand forecasting.

Hereinafter, an HFM according to the above embodiment and power demand forecasting results using MIDAS and LSTM methods compared thereto will be described.

Good performance for deep learning may be achieved by appropriately setting hyper-parameters that are external variables. That is, the optimal number of layers, nodes, iterations, and activation functions, etc. must be set. In general, it is necessary to find the most optimal hyper-parameter setting according to the number or purpose of the data, and it was found that optimal results were obtained through a total of 40 settings in the hyper-parameter setting. For the optimal setting, the number of hidden layers was set to 3, the number of nodes was set to 10, the learning rate was set to 0.01, and the number of iterations was set to 180. In the experiments of the present disclosure, hyperbolic tangent (tank) and stochastic gradient descent (SGD) were used as the activation function and optimization algorithm of an LSTM layer, respectively. In a classification LSTM model, cross-entropy (CE) and sum of square errors (SSE) are used as loss functions for forecast using multiclass classification, but mean square error (MSE) is predominantly used for forecast using regression. Therefore, in the experiments of the present disclosure, the MSE was used as a loss function to reduce the forecast error. Table 2 shows a total of three results showing the highest accuracy obtained in the experiments to find the optimized hyper-parameters. Different forecast results were shown according to each setting, and Setting 3, which had the highest accuracy, was used.

TABLE 2

| Hyper parameter | Setting 1 | Setting 2 | Setting 3 |
|---|---|---|---|
| Hidden layer | 2 | 3 | 3 |
| The number of nodes | 10 | 8 | 10 |
| Learning rate | 0.001 | 0.01 | 0.01 |
| The number of iterations | 180 | 180 | 180 |
| Activation function | Softmax | tanh | tanh |
| Optimization algorithm | SGD | SGD | SGD |
| Loss function | MSE | MSE | MSE |

Tables 3, 4, and 5 below show the statistical analysis for experiments in which power demand forecasting was performed on each facility building. Table 3 shows results of short-term forecasting, Table 4 shows results of long-term forecasting, and Table 5 shows seasonal forecasting results of residential facilities. In the case of the short-term forecasting, the value of MAPE shows a significant decrease for each facility. However, in the case of the long-term forecasting, the value of MAPE does not show a significant difference.

TABLE 3

| Model | Index | Residential | City Hall | Factory | Hospital |
|---|---|---|---|---|---|
| MIDAS | MAPE (%) | 21.040 | 15.680 | 7.210 | 7.100 |
| | RMSE | 7.940 | 20.070 | 46.890 | 30.930 |
| | R² | 0.302 | 0.750 | 0.370 | 0.926 |
| LSTM | MAPE (%) | 19.401 | 4.714 | 4.060 | 2.892 |
| | RMSE | 3.365 | 7.623 | 23.302 | 15.246 |
| | R² | 0.712 | 0.959 | 0.830 | 0.977 |
| HEM | MAPE (%) | 10.440 | 2.730 | 1.630 | 1.960 |
| | RMSE | 1.720 | 7.190 | 12.510 | 15.570 |
| | R² | 0.917 | 0.962 | 0.893 | 0.981 |

TABLE 4

| Model | Index | Residential | City Hall | Factory | Hospital |
|---|---|---|---|---|---|
| MIDAS | MAPE (%) | 34.610 | 11.500 | 7.380 | 4.040 |
| | RMSE | 7.950 | 17.560 | 59.700 | 37.070 |
| | R² | 0.416 | 0.700 | 0.231 | 0.891 |
| LSTM | MAPE (%) | 32.594 | 9.830 | 7.710 | 4.080 |
| | RMSE | 8.020 | 17.040 | 62.130 | 38.100 |
| | R² | 0.439 | 0.766 | 0.235 | 0.880 |
| HEM | MAPE (%) | 32.500 | 8.700 | 7.700 | 4.050 |
| | RMSE | 7.330 | 14.490 | 53.610 | 36.800 |
| | R² | 0.585 | 0.752 | 0.248 | 0.895 |

TABLE 5

| | MAPE (%) | | RMSE | | R² | |
|---|---|---|---|---|---|---|
| Model | Winter | Summer | Winter | Summer | Winter | Summer |
| MIDAS | 16.050 | 10.221 | 4.632 | 4.358 | 0.815 | 0.729 |
| LSTM | 16.200 | 6.520 | 12.628 | 2.830 | 0.094 | 0.886 |
| HFM | 12.279 | 5.400 | 4.400 | 2.740 | 0.857 | 0.896 |

Unlike the forecasting result of the residential facilities in Table 4, it can be confirmed that the error rate was significantly reduced in the seasonal power demand forecasting of the residential facilities in Table 5, In winter experiments, power demand forecasting was performed in a state in which forecasted data includes holidays. In the present embodiment related to the HFM, a higher weight was assigned to a holiday before a day to be forecasted by using a weighting method to thereby reduce the forecast error rate. However, in the existing simple LSTM method, weight is not assigned. Thus, the LSTM method showed the lowest performance, as shown in Table 5.

Comparative experiments with results from short-term, long-term, and seasonal experiments using three models (MIDAS, LSTM, and HFM) were performed through a nonparametric statistical test called the Friedman test. The Friedman test generally uses rank comparison rather than comparing original values. In Table 6, it is confirmed that N is the number of total MAPE results (short-term, long-term, and seasonal), Chi-squared is 8.6, degree of freedom (DF) is 2, and the p-value is 0.018. A value a is set to a 0.05 significance level, which is commonly used.

TABLE 6
Friedman Test

| | |
|---|---|
| N | 10 |
| Chi-squared | 8.6 |
| Degree of freedom (DF) | 2 |
| p-value | 0.018 |

The present disclosure proposes an HFM for forecasting power demand optimized for short-term data by using only past power demand data. The accuracy of the power demand forecasting depends on data preprocessing and weight function. In addition, it is important to set up a model that is capable of closely following the pattern of power demand volatility over time. In Table 4, it is confirmed that the HEM better reflects the power demand volatility than the other two methods (MIDAS and LSTM). Because general industrial facilities show similar power demand patterns every day, the HFM is very efficient for short-term power demand forecasting. On the other hand, facility buildings that tend to sensitively respond to weekend and weather influences have to be seasonally classified and then included in the HFM.

By summarizing the experimental results, it was confirmed that the forecasting accuracy for residential facilities was the lowest, while factory and hospital facilities showed a high accuracy with a relatively low level of error rate. The HEM of short-term data showed a higher level of forecasting than the other two methods (MIDAS and LSTM). Also, the results of the short-term data are relatively better than those of the long-term data. It was confirmed that, in the case of short-term forecasting of the HEM, the value of MAPE decreases by 10.44% p in the residential building, by 12.87% p in the public institution building, by 5.58% p in the factory building, and by 5.14% p in the hospital building. On the other hand, it was confirmed that, in the case of long-term forecasting of the HEM, the value of MAPE decreases by 2.11% p in the residential building and by 2.8% p in the public institution building. In addition, in the long-term forecasting, the error rates in power demand forecasting at factory and hospital facilities were not improved. In general, power demand forecasting using short-term data more accurately reflects the volatility, thereby improving the accuracy of the forecasting. However, power demand forecasting using long-term data is highly influenced by weather and external factors, and thus, the accuracy of the forecasting does not show much difference, even though the overall accuracy is higher due to the larger number of datasets, Because the power demand forecasting is related to the volatility of data patterns, it was confirmed that short-term volatility patterns may not be properly utilized in long-term demand forecasting.

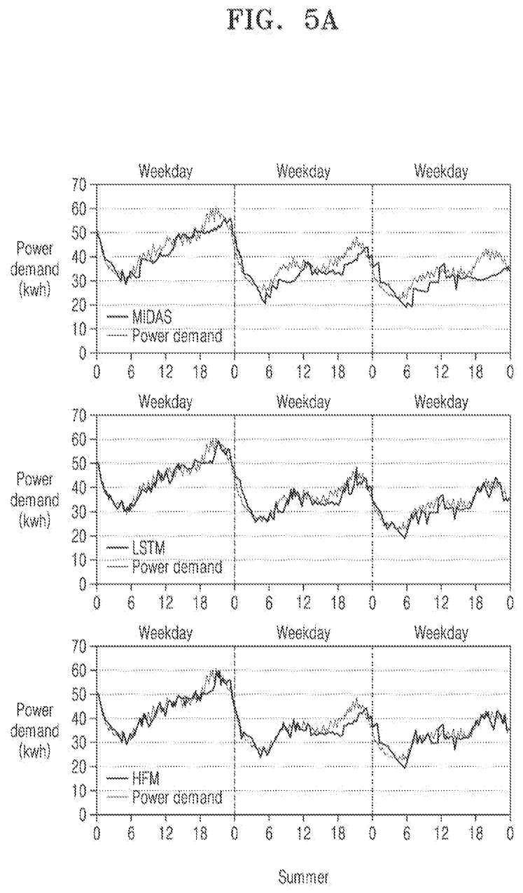

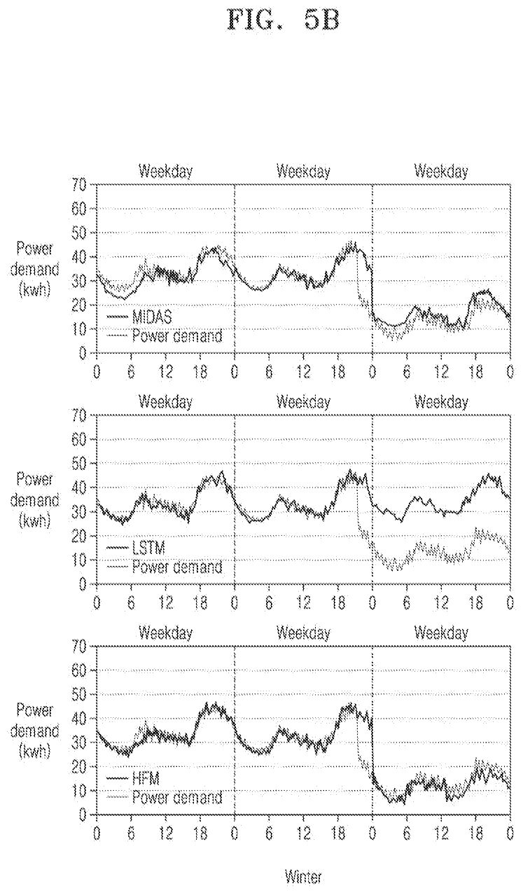

Through the experiments of the present embodiment, it was confirmed that the forecasting of power demand in residential facilities that are sensitive to weather, seasonal, and holiday influences may achieve higher accuracy by seasonally categorizing and forecasting data considering the weights for special situations, as shown in FIGS. 5A and 5B.

FIGS. 5A and 5B illustrate comparisons of results of forecasting power demand in residential facilities in summer by using the existing MIDAS model and powerLSTM model and the HFM of the present disclosure. The MAPE value of the HFM is 5.400% and the MAPE value of the PowerLSTM model is 8.935%. The difference between the MAPE value of the HFM and the MAPE value of the PowerLSTM model is 3.535%, and the HFM has a MAPE value that is lower by 39.564% compared to that of the PowerLSTM model. In addition, through a Friedman test, it was confirmed that the HFM is more meaningful than the MIDAS or LSTM model for the values of each experiment. Specifically, it was confirmed that the p-value of the HFM is less than the significance level α (p<0.05). Therefore, it may be said that the results of the HFM were showed to be statistically significant through the Friedman test.

In conclusion, the existing power demand forecasting method using the regression analysis method requires many external factors, in addition to the previous power demand data. However, in the HFM of the present disclosure, it is possible to forecast power demand, with reduced error rates, only by previous power demand data.

Through the experiments on the HFM of the present disclosure, different power demand patterns were shown depending on facilities, and it was confirmed that, in particular, residential facilities are greatly influenced by seasonal and temperature factors. Because only power demand data was used as input data when forecasting power demand in residential facilities by using short-term data and long-term data, the forecasting error rate of the residential facilities increased compared to other facilities. However, the accuracy of forecasting was improved by performing seasonal experiments by classifying data by season that affects the power demand.

According to the present disclosure, it may be expected that there will be further future studies, which may provide efficient and accurate forecasting of power demand by adding data on external factors affecting power demand forecasting and previous power demand data. In addition, forecasting accurate power demand with high performance would be contributed to the sustainable development of the natural environment and environment management area, which are nowadays great issues all over the world.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

What is claimed is:

1. A method of forecasting power demand, the method comprising:
measuring and collecting periodic power demand data for one facility or each facility of a plurality of same or different facilities;
forming weighted power demand data by assigning different weights to the power demand data according to frequency of the power demand data;
forming a power demand forecasting model by recurrent neural network (RNN)-based deep learning using the weighted power demand data; and
extracting a power demand forecasting value of a label or index by using a forecast target label or index information in the power demand forecasting model.

2. The method of claim 1, wherein the forming of the power demand forecasting model by the RNN-based deep learning is based on long short-term memory (LSTM).

3. The method of claim 2, further comprising:
setting hyper-parameters of the LSTM,
wherein, in the setting of the hyper-parameters, a number of hidden layers is set to 3, a number of nodes is set to 10, a learning rate is set to 0.01, and a number of iterations is set to 180.

4. The method of claim 2, wherein hyperbolic tangent (tank) and stochastic gradient descent (SGD) are respectively used as an activation function and an optimization algorithm of a layer of the LSTM.

5. The method of claim 2, wherein a mean square error (MSE) is used as a loss function of the layer of the LSTM.

6. The method of claim 1, wherein deeplearning4J (DL4J) using a graphic processing unit (GPU) is applied to the RNN-based deep learning.

7. The method of claim 1, wherein the forming of the weighted power demand data (x′) is performed using a weight function according to <Equation> below,
x′ₜⁿ= [symbol] xₜⁿ+b <Equation>
where W denotes a vector matrix,
x denotes raw data,
n denotes a serial number or number in a specific period,
t denotes a serial number or ordinal number of data in a specific period, and
b denotes a bias coefficient.

8. An apparatus for forecasting power demand, the apparatus comprising:
a power demand forecasting unit configured to forecast power demand of one facility or each facility of a plurality of same or different facilities;
a processor configured to perform data processing requested by the power demand forecasting unit;
a memory used by the processor; and
a display configured to display a result of processing by the power demand forecasting unit,
wherein the power demand forecasting unit is further configured to:
measure and collect periodic power demand data for the one facility or the each facility of the plurality of same or different facilities, and form weighted power demand data by assigning different weights to the power demand data according to frequency of the power demand data;
form a power demand forecasting model by recurrent neural network (RNN)-based deep learning using the weighted power demand data; and
extract a power demand forecasting value of a label or index by using a forecast target label or index information in the power demand forecasting model.

9. The apparatus of claim 8, wherein the power demand forecasting unit is further configured to form the power demand forecasting model through the RNN-based deep learning based on long short-term memory (LSTM).

10. The apparatus of claim 8, wherein the power demand forecasting unit is further configured to set hyper-parameters of the LSTM, wherein a number of hidden layers is set to 3, a number of nodes is set to 10, a learning rate is set to 0.01, and a number of iterations is set to 180.

11. The apparatus of claim 9, wherein hyperbolic tangent (tank) and stochastic gradient descent (SGD) are respectively used as an activation function and an optimization algorithm of a layer of the LSTM.

12. The apparatus of claim 9, wherein a mean square error (MSE) is used as a loss function of the layer of the LSTM.

13. The apparatus of claim 8, further comprising:
a graphic processing unit (GPU), wherein the power demand forecasting unit is further configured to apply deeplearning4J (DL4J) using the GPU to the RNN-based deep learning.

14. The apparatus of claim 10, wherein the power demand forecasting unit is further configured to form the weighted power demand data (x′) by using a weight function according to <Equation> below,
x′ₜⁿ= [symbol] xₜⁿ+b <Equation>
where W denotes a vector matrix,
x denotes raw data,
n denotes a serial number or number in a specific period,
t denotes a serial number or ordinal number of data in a specific period, and
b denotes a bias coefficient.

15. The apparatus of claim 8, wherein the power demand forecasting unit is further configured to form the weighted power demand data (x′) by using a weight function according to <Equation> below,
x′ₜⁿ= [symbol] xₜⁿ+b <Equation>
where W denotes a vector matrix,
x denotes raw data,
n denotes a serial number or number in a specific period,
t denotes a serial number or ordinal number of data in a specific period, and
b denotes a bias coefficient.

16. The method of claim 8, the power demand forecasting unit is implemented in software form including a single piece of software or a group of a plurality of pieces of software in a form of modules separated by function.
